(19) United States
(12) Patent Application Publication
(10) Pub. No.: US 2025/0282312 A1
(43) Pub. Date: Sep. 11, 2025

(54) Vehicle Electronic Component Holder Set And Vehicle Electronic Component Holder

(71) Applicant: SUMIDA CORPORATION, Tokyo (JP)

(72) Inventor: Noriaki IWASAKI, Natori City (JP)

(21) Appl. No.: 19/218,838

(22) Filed: May 27, 2025

Related U.S. Application Data
(63) Continuation of application No. PCT/JP2022/046639, filed on Dec. 19, 2022.

(51) Int. Cl. B60R 16/023

(52) U.S. Cl. CPC B60R 16/0239

(57) ABSTRACT

A vehicle electronic component holder set includes a shaft member having a circular cross section, and a vehicle electronic component holder. The vehicle electronic component holder includes a base portion provided with an attachment hole through which the shaft member is inserted. The base portion includes a protrusion protruding from a peripheral wall defining the attachment hole toward an inside of the attachment hole. As viewed from the depth direction of the attachment hole, a distance between the protrusion and a center of the attachment hole is smaller than a radius of the shaft member. When the shaft member is inserted into the attachment hole, the protrusion comes into pressure contact with a side surface of the shaft member.

### CROSS REFERENCE TO RELATED APPLICATIONS

This application claims priority to International Patent Application No. PCT/JP2022/046639, filed on Dec. 19, 2022, which is expressly incorporated herein by reference in its entirety.

### BACKGROUND

### Technical Field

The present invention relates to a vehicle electronic component holder set and a vehicle electronic component holder.

### Related Art

A holder may be used to attach and hold a coil component to another member.

Regarding this type of technology, JP 2016-100610 A discloses an antenna device (10) that is attached to another member such as a bumper (31a) of a vehicle body (30a) using a case (3) having a case main body (3b) in which an antenna coil (1) is accommodated and a flange portion (3f). Specifically, as shown in FIG. 2 of the same document, the flange portion (3f) has a through hole (3fb), and the antenna device (10) is attached to another member by inserting an attachment screw into the through hole (3fb) and fastening the attachment screw.

When the flange portion (3f) provided with the through hole (3fb) is attached to an installation surface of another member, a shaft portion of an attachment screw is inserted into the through hole (3fb) and the screw hole of the installation surface, and the flange portion (3f) is sandwiched and held between a screw head having a diameter larger than that of the through hole (3fb) and the installation surface, whereby the antenna device (10) is held by the another member. In general, the through hole (3fb) is formed so that the diameter of the through hole (3fb) is larger than the outer diameter of the shaft portion of the attachment screw. Thus, only by inserting the mounting screw into the through hole (3fb) and the screw hole, the relative position of the antenna device with respect to the attachment screw and other members is not fixed. That is, it is necessary to fix the antenna device (10) at a desired mounting position on another member by the installer himself or herself or some sort of tool until the mounting screw is completely tightened. As described above, when the antenna device of JP 2016-100610 A is attached to another member, it takes time and effort to hold the antenna device at a desired attachment position of the another member.

The present invention has been made in view of the above-described problems, and an object of the present invention is to provide an electronic component holder that is easily attached.

### SUMMARY

A vehicle electronic component holder set according to the present invention is a vehicle electronic component holder set including: a shaft member having a circular cross section; and a vehicle electronic component holder, wherein the vehicle electronic component holder includes a base portion provided with an attachment hole through which the shaft member is inserted, the base portion includes a protrusion protruding from a peripheral wall defining the attachment hole toward an inside of the attachment hole, a distance between the protrusion and a center of the attachment hole is smaller than a radius of the shaft member as viewed from a depth direction of the attachment hole, and when the shaft member is inserted into the attachment hole, the protrusion comes into pressure contact with a side surface of the shaft member.

A vehicle electronic component holder according to the present invention is a vehicle electronic component holder used together with a shaft member having a circular cross section, the vehicle electronic component holder including: a base portion provided with an attachment hole through which the shaft member is inserted, wherein the base portion includes a protrusion protruding from a peripheral wall defining the attachment hole toward an inside of the attachment hole.

Since the distance between the protrusion and the center of the attachment hole as viewed from the depth direction of the attachment hole is smaller than the radius of the shaft member, when the shaft member is inserted into the attachment hole, the peripheral wall including the protrusion is pushed and expanded outward by the shaft member, and the shaft member is gripped by the protrusion and its facing portion. Therefore, the electronic component holder is fixed to the shaft member only by inserting the shaft member into the attachment hole.

### Effect of the Invention

According to a vehicle electronic component holder set of the present invention, when a shaft member is inserted into an attachment hole, a relative position between the shaft member and the electronic component holder is fixed, so that the electronic component can be easily installed on another member.

### BRIEF DESCRIPTION OF THE DRAWINGS

The foregoing and other objects, features, and advantages will become more apparent from the following preferred embodiments and accompanying drawings.

FIG. 1 is a perspective view showing an example of a vehicle electronic component holder set in an attached state according to a first embodiment of the present invention.

FIG. 2 is a top view of the vehicle electronic component holder set in the attached state according to the first embodiment.

FIG. 3 is a bottom view of the vehicle electronic component holder according to the first embodiment.

FIG. 4 is a longitudinal sectional view along an x-axis direction of the vehicle electronic component holder set in the attached state according to the first embodiment.

FIG. 5A is a top view showing a base portion of the vehicle electronic component holder set in an attached state according to the first embodiment.

FIG. 5B is a bottom view showing the base portion of the vehicle electronic component holder in the attached state according to the first embodiment. In FIG. 5B, an installation surface is not shown, and only an outer edge of a shaft member is indicated by a dotted line.

FIG. 6A is a longitudinal cross-sectional view along the x-axis direction of the base portion of the vehicle electronic component holder in the attached state according to the first embodiment.

FIG. 6B is a cross-sectional view of a cross section taken along a one-dot chain line shown in FIG. 5A as viewed in a direction of arrows VI-VI.

FIG. 6C is an enlarged view of a protrusion and the vicinity thereof in the drawing of FIG. 6B.

FIG. 7A is a top view showing a base portion different from that in FIG. 5A of the vehicle electronic component holder set in the attached state according to the first embodiment.

FIG. 7B is a bottom view showing a base portion different from that in FIG. 5B of the vehicle electronic component holder set in the attached state according to the first embodiment. In FIG. 7B, an installation surface is not shown, and only an outer edge of a shaft member is indicated by a dotted line.

FIG. 8A is a cross-sectional view of the vehicle electronic component holder in the attached state according to the first embodiment as viewed in a direction of arrows VIIIa-VIIIa along a one-dot chain line shown in FIG. 7A.

FIG. 8B is a cross-sectional view of the vehicle electronic component holder in the attached state according to the first embodiment as viewed in a direction of arrows VIIIb-VIIIb along a one-dot chain line shown in FIG. 7A.

### DETAILED DESCRIPTION

The various constituent elements of the coil component of the present invention do not need to be independent from each other, and it is allowable that a plurality of constituent elements is formed as one member, one constituent element is formed of a plurality of members, one constituent element is a part of another constituent element, a part of one constituent element overlaps with a part of another constituent element, and the like.

Hereinafter, embodiments of the present invention will be described with reference to the drawings. In the drawings, corresponding components are denoted by the same reference numerals, and redundant description will not be repeated as appropriate.

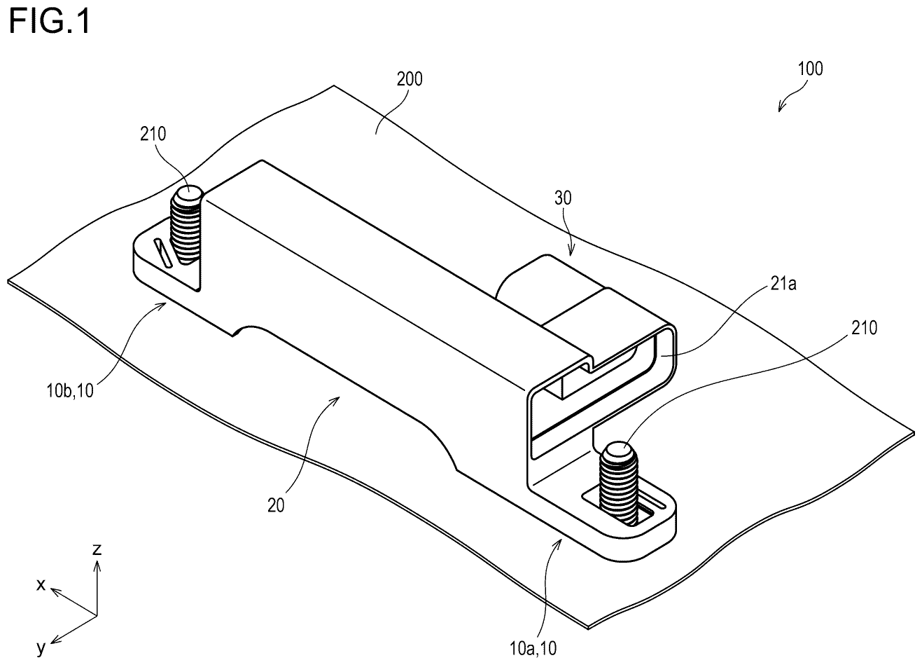

In the present embodiment, an electronic component holder set will be described by defining x, y, and z coordinates shown in FIG. 1. A z-axis direction coincides with an axial direction of a shaft member and a depth direction of an attachment hole. In the present embodiment, a side on which another member (also referred to as an attachment destination member) to which an electronic component holder is to be attached is referred to as a lower side, a side opposite to the lower side is referred to as an upper side, and a direction (x-axis direction or y-axis direction) orthogonal to a vertical direction (z-axis direction) is referred to as a lateral direction or a side direction. However, this is defined for convenience in order to simply describe the relative relationship of the components, and does not limit the direction at the time of manufacturing or using the product for carrying out the present invention. Further, a center side of the electronic component holder is referred to as an inner side, and a side opposite to the inner side is referred to as an outer side.

In addition, the plane referred to in the present invention means a shape physically formed with a plane as a target, and it is needless to say that it is not necessarily a geometrically perfect plane.

### First Embodiment

### (Electronic Component Holder Set)

FIG. 1 is a perspective view showing an example of a vehicle electronic component holder set according to a first embodiment of the present invention.

First, an outline of a vehicle electronic component holder set according to the present embodiment will be described.

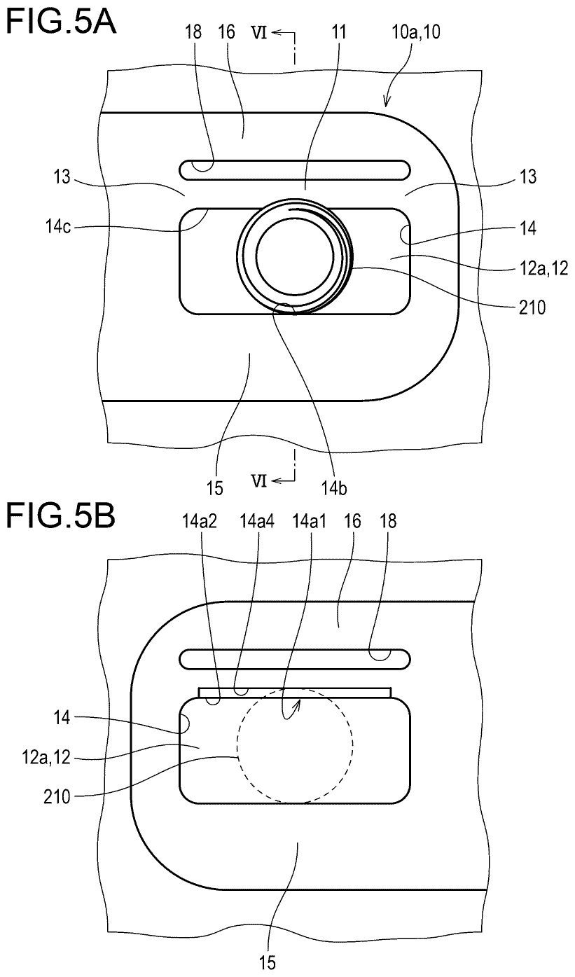

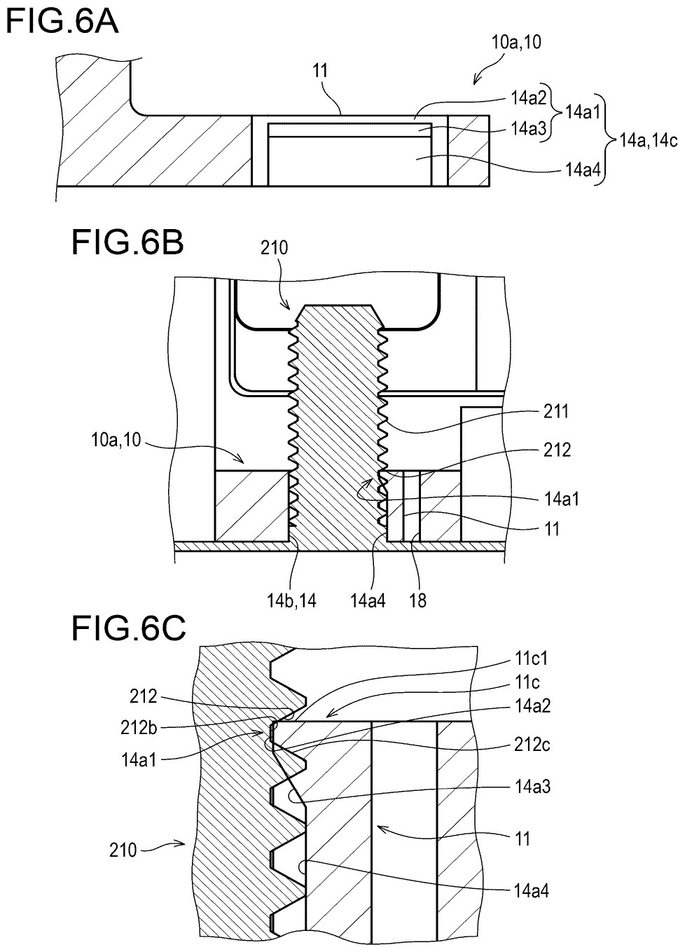

The vehicle electronic component holder set (hereinafter, also simply referred to as an electronic component holder set) includes a shaft member 210 having a circular cross section, and a vehicle electronic component holder (hereinafter, also simply referred to as the electronic component holder 100). The electronic component holder 100 has a base portion 10 provided with an attachment hole 12 (see FIG. 5A) through which the shaft member 210 is inserted. The base portion 10 has a protrusion 14al (see FIG. 6B) protruding from a peripheral wall 14 (see FIG. 5A) defining the attachment hole 12 toward the inside of the attachment hole 12. When viewed from the depth direction of the attachment hole 12, a distance between the protrusion 14a1 and a center of the attachment hole is smaller than the radius of the shaft member 210. When the shaft member 210 is inserted into the attachment hole 12, the protrusion 14a1 comes into pressure contact with a side surface of the shaft member 210.

With the configuration of the electronic component holder 100 as described above, when the shaft member 210 is inserted into the attachment hole 12 as described later, the peripheral wall 14 including the protrusion 14a1 is pushed and expanded by the shaft member 210. Since the peripheral wall 14 pushed and expanded tends to deform toward a center of the attachment hole 12 by its own elastic restoring force, the protrusion 14al comes into pressure contact with the side surface of the shaft member 210. That is, since the shaft member 210 is gripped by the protrusion 14al and one or more facing portions 14b to be described later, the base portion 10 is fixed to the shaft member 210. Thus, the electronic component holder 100 can be fixed to the periphery of the shaft member 210 in a desired positional relationship only by disposing the base portion 10 so that the shaft member 210 is inserted into the attachment hole 12.

Next, the vehicle electronic component holder set of the present embodiment will be described in detail.

The vehicle electronic component holder set includes a vehicle electronic component holder and one or a plurality of other members. In addition, the vehicle electronic component holder is a member for attaching and holding an electronic component at a desired position of another member (hereinafter, also referred to as an attachment destination member) in the vehicle. Examples of a place where the electronic component is mounted include a wall portion in the vehicle, a ceiling, a vehicle body such as above a floor or below a floor, or a part in a console box or a trunk room. The electronic component holder 100 may be attached to a desired position in the vehicle in any orientation. For example, in the attached state, any of the x-axis direction, the y-axis direction, and the z-axis direction may be the direction in which gravity is applied.

Here, the electronic component is a component constituting a device mounted on a vehicle, and a component having a coil is exemplified. Examples of the coil component include an antenna.

The electronic component holder 100 may hold the electronic component on the attachment destination member by itself, or may hold the electronic component on the attachment destination member by being used together with another member. For example, as described later, a case portion 20 to which an electronic component is attached may be provided as a separate member from the flange portion 10, and the base portion 10 may connect the case portion 20 and the attachment destination member to each other, so that the base portion 10 and the case portion 20 may function as the electronic component holder 100.

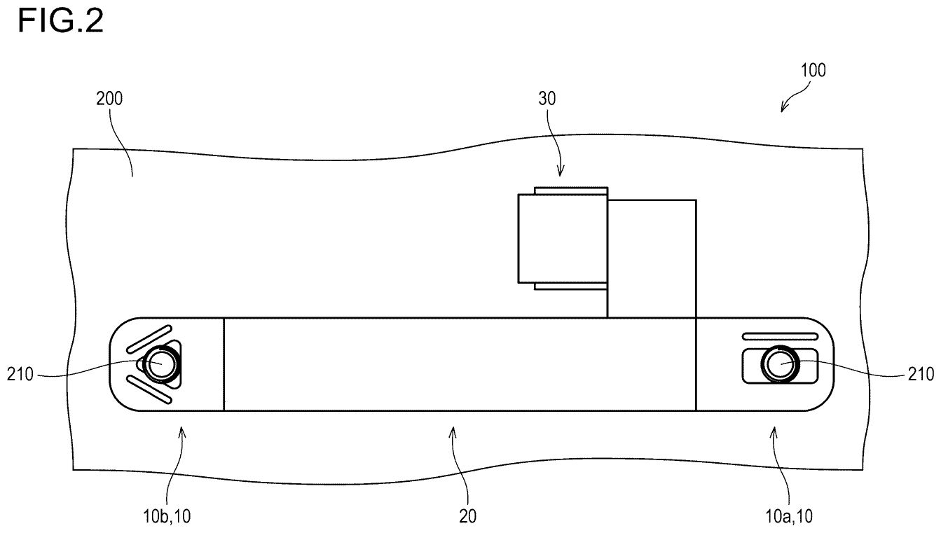

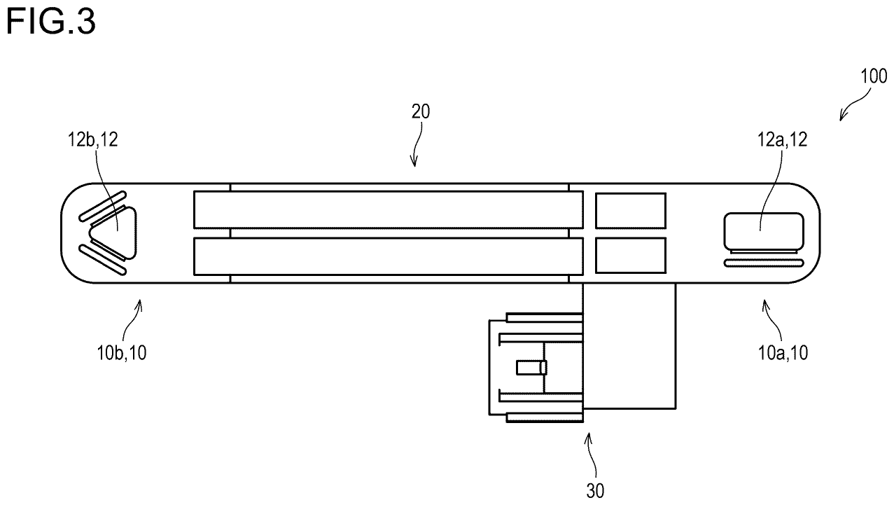

The electronic component holder 100 of the present embodiment is integrally formed of resin. As shown in FIGS. 2 and 3, the electronic component holder 100 has an elongated outer shape whose longitudinal direction is the x-axis direction as a whole. In particular, the case portion 20 described later is a member elongated in the x-axis direction. Although an installation surface 200 shown in FIG. 1 is a flat surface and represents a part of a surface of the attachment destination member, the installation surface 200 may be a surface having irregularities instead of a flat surface, or may be a curved surface.

The base portion 10 in the electronic component holder 100 is a portion connected to the shaft member 210. Specifically, the base portion 10 is a member including a portion where the attachment hole 12 to be described later is formed and the vicinity thereof.

In the present embodiment, the electronic component holder 100 has a case portion 20 described later in detail, and as shown in FIG. 2, two plate-like members (referred to as flange portions) are provided so as to protrude from the case portion 20 toward both sides in the x-axis direction in a flange shape. In other words, the electronic component holder 100 has two flange portions at both ends in the longitudinal direction of the electronic component holder 100. As shown in FIG. 3, the attachment hole 12 is formed substantially at a center of each of the flange portions. The base portion 10 in the present embodiment is a flange portion (hereinafter referred to as the flange portion 10) provided with the attachment hole 12. Unlike the present embodiment in which the attachment hole 12 is provided at a center of the flange portion 10, when the attachment hole 12 is formed on a proximal end side (the case portion 20 side) of the flange portion 10, a part of the case portion 20 (a part of the flange portion 10 side) may also be referred to as the base portion 10 in addition to the flange portion 10.

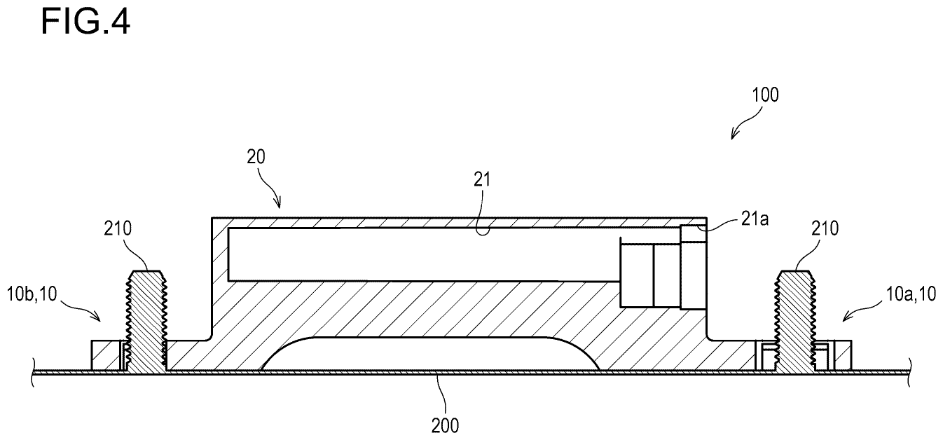

As shown in FIG. 4, in the present embodiment, the base portion 10 is provided below a center (on the installation surface 200 side) in the thickness direction (z-axis direction) of the electronic component holder 100. More specifically, the base portion 10 is disposed on the lowermost side of the electronic component holder 100 in the z-axis direction, and a lower surface of the base portion 10 is the lowermost surface of the electronic component holder 100. The base portion 10 may be provided in the middle of the electronic component holder 100 in the z-axis direction. That is, a lower surface of the case portion 20 may be in contact with the installation surface 200, and the flange portion 10 may be separated from the installation surface 200. Further, a spacer member (not shown in the drawings) may be interposed between the electronic component holder 100 and the installation surface 200.

As shown in FIGS. 2 and 4, the flange portion 10 has a flat shape in which a dimension in the z-axis direction is sufficiently smaller than dimensions in the x-axis direction and the y-axis direction and which extends in the lateral direction. When viewed in the z-axis direction, the flange portion 10 has a rectangular shape that is horizontally long in the x-axis direction. The surface of the flange portion 10 facing the z-axis direction is referred to as a main surface. Unlike the present embodiment, even when the base portion 10 has a large dimension in the z-axis direction and the base portion 10 is not a plate-like member, a surface of the base portion 10 facing the z-axis direction is referred to as a main surface.

The base portion 10 is not limited to have a flange shape protruding from the case portion 20. For example, the base portion 10 may be included in an envelope volume of the case portion 20 without protruding from the case portion 20, or may have a shape in which the base portion 10 and the case portion 20 cannot be clearly separated at a glance. Further, the base portion 10 is not limited to the plate shape, and may have a thickness (dimension in the z-axis direction) larger than the dimension in the lateral direction.

Further, as described later in the modification, the electronic component holder 100 is not limited to have the two base portions 10, and may have one or three or more base portions 10.

The attachment hole 12 is a hole through which the shaft member 210 is inserted. In the present embodiment, as shown in FIG. 3, the attachment hole 12 is formed as, but is not limited to, a through hole penetrating the flange portion 10 in the z-axis direction. When the base portion 10 is sufficiently thick, the attachment hole 12 may be a recess provided in the base portion 10 and having a bottom surface. In this case, the shaft member 210 is inserted from the opening side of the attachment hole 12.

In the present embodiment, as described above, each of the two flange portions 10 (first flange portion 10a and second flange portion 10b) is provided with one attachment hole 12 (first attachment hole 12a or second attachment hole 12b). One or a plurality of attachment holes 12 may be provided for one flange portion 10.

In the present embodiment, the first attachment hole 12a is a horizontally long rectangle in the x-axis direction as viewed in the z-axis direction, and the second attachment hole 12b is an equilateral triangle as viewed in the z-axis direction. The shape of the attachment hole 12 as viewed from the z-axis direction may be any shape, and examples thereof include a circular shape, an elliptical shape, and a polygonal shape.

Hereinafter, first, the attachment hole 12 and the flange portion 10 will be described while exemplifying the first attachment hole 12a and the first flange portion 10a. Features of the attachment hole 12 and the flange portion 10 described below also apply to the second attachment hole 12b and the second flange portion 10b. Specific features of the second attachment hole 12b and the second flange portion 10b will be described later.

As shown in FIGS. 6A and 6B, the attachment hole 12 is defined by a peripheral wall 14 having a dimension in a depth direction (z-axis direction) of the attachment hole 12.

In the present embodiment, the peripheral wall 14 of the attachment hole 12 is formed so that a part of the surface is recessed and the remaining portion protrudes. Specifically, as shown in FIGS. 6A and 6B, in a protrusion forming region 14a to be described later, a part of a wall surface (a recessed surface 14a4 to be described later) on the lower end side is recessed in the −y direction (the depth side of the paper surface in FIG. 6A) with respect to a part (the protrusion 14a1) on the upper end side. The recessed surface 14a4 is also a part of the peripheral wall 14.

The protrusion 14a1 is a portion protruding toward the inside of the attachment hole 12 from a part of the peripheral wall 14.

Hereinafter, as shown in FIG. 6A, a part of the peripheral wall 14 on which the protrusion 14al is formed is referred to as a protrusion forming region 14a. The protrusion forming region 14a is a part of the peripheral wall 14 overlapping the protrusion 14a1 in the depth direction (z direction) of the attachment hole 12. In the present embodiment, as shown in FIG. 5A, the shape of the attachment hole 12 as viewed in the z-axis direction is a polygon, and the peripheral wall 14 has a flat portion constituting one side of the polygon. As shown in FIG. 6A, in the present embodiment, the entire one flat portion is a protrusion forming region 14a. In the attachment hole 12 of the present embodiment, a protrusion 14a1 is formed in a part (uppermost end portion) of the protrusion forming region 14a on the upper side. Specifically, as shown in FIGS. 5B and 6B, a part of the protrusion forming region 14a on the lower side (recessed surface 14a4) is formed to be recessed from a part of the peripheral wall 14 connected to the protrusion forming region 14a in the circumferential direction and a top surface 14a2 to be described later. In addition, the protrusion 14a1 (particularly, the top surface 14a2) protrudes toward the inside of the attachment hole 12 more than the recessed surface 14a4. Here, the protrusion 14a1 protruding toward the inside of the attachment hole 12 means that the protrusion protrudes toward the side approaching the center of the attachment hole 12 in plan view. However, the protrusion 14a1 does not necessarily protrude straight toward the center of the attachment hole 12. In the present embodiment, the protrusion 14al protrudes toward the side approaching the center of the attachment hole 12 in the direction perpendicular to the surface of the protrusion forming region 14a. In other words, the protrusion 14a1 protrudes so as to stand in a direction perpendicular to the surface of the protrusion forming region 14a.

As described above, the peripheral wall 14 is provided with an uneven shape, but as shown in FIG. 5A, the outer edge of the attachment hole 12 in a plan view is configured so that a curve and a straight line are smoothly connected. In other words, as shown in FIG. 5B, the tip of the protrusion 14al (a top surface 14a2 to be described later) is smoothly connected to a part of the peripheral wall 14 continuous with the protrusion forming region 14a in the circumferential direction (here, in the peripheral wall 14, a curved portion defining a corner of the attachment hole 12 having a polygonal shape is formed) without a step. That is, both ends of the top surface 14a2 are smoothly connected to the curved portion without a step.

In the first attachment hole 12a, two flat portions (facing portion 14b, attachment hole facing surface 14c) are arranged substantially parallel to each other, and one flat portion (attachment hole facing surface 14c) entirely constitutes the protrusion forming region 14a. As a result, the side surface of the shaft member 210 and the protrusion 14a1 come into pressure contact with each other in substantially the same mode regardless of where the shaft member 210 is disposed in a center or an end of the first attachment hole 12a in an extending direction (x-axis direction) of the flat portion (attachment hole facing surface 14c).

Instead of the present embodiment, only a part of the flat portion (attachment hole facing surface 14c) may be the protrusion forming region 14a. For example, a part of one end side of the flat portion in an extending direction of a leaf spring portion 11 described later or an intermediate portion of the flat portion in the extending direction of the leaf spring portion 11 may be the protrusion forming region 14a. When a part of the flat portion is the protrusion forming region 14a, a part of the center of the flat portion is preferably the protrusion forming region 14a.

In the present embodiment, as shown in FIGS. 6A and 6B, the protrusion 14al is provided at the uppermost end of the peripheral wall 14, but is not limited thereto. The protrusion 14a1 may also be provided at an intermediate portion of the peripheral wall 14 in the depth direction of the attachment hole 12, or may be provided at the lowermost end. In a case where the protrusion 14a1 is provided at the end portion (upper end portion or lower end portion) of the peripheral wall 14 in the depth direction of the attachment hole 12, when the shaft member 210 is inserted into the attachment hole 12, one end (for example, upper end) offset from the center in the depth direction of the peripheral wall 14 provided with the protrusion 14al in the depth direction of the attachment hole 12 is pushed outward of the attachment hole 12 by the shaft member 210. As a result, the leaf spring portion 11 is expanded outward of the attachment hole 12 while being twisted so as to rotate with respect to the extending direction of the leaf spring portion 11 about the other end (for example, the lower end) of the leaf spring portion 11 to be described later in the depth direction of the attachment hole 12. In this case, it is easy to bend the leaf spring portion 11 as compared with the case where the protrusion 14a1 is provided in the intermediate portion of the peripheral wall 14 in the depth direction of the attachment hole 12. Further, in the peripheral wall 14, the protrusion 14a1 is provided at the end portion (lower end portion in the present embodiment) on the side where the shaft member 210 enters when the shaft member 210 is inserted into the attachment hole 12, so that the protrusion 14a1 can be brought into pressure contact with the side surface of the shaft member 210 even when the shaft member 210 is short. In addition, in the peripheral wall 14, the protrusion 14a1 is provided at the end portion (the upper end portion in the present embodiment) opposite to the side where the shaft member 210 enters when the shaft member 210 is inserted into the attachment hole 12, and the lower end portion is recessed more than the protrusion 14a1, so that a sufficient dimension for inserting the shaft member 210 is ensured in the attachment hole 12. Therefore, the shaft member 210 can be easily inserted into the attachment hole 12. In addition, by providing the protrusion 14a1 at the upper end portion far from the installation surface 200, a large moment can be applied to the shaft member 210, and the protrusion 14a1 favorably comes into pressure contact with the side surface of the shaft member 210.

In addition, a plurality of protrusions 14al may be provided in the peripheral wall 14. For example, as in a second attachment hole 12b to be described later, two protrusions 14a1 may be disposed apart from each other in the circumferential direction of the peripheral wall 14. Further, the plurality of protrusions 14al may be arranged to be separated from each other in the z-axis direction. The circumferential direction of the peripheral wall 14 is an extending direction of the peripheral wall 14, and is a direction when the peripheral wall 14 goes around the periphery of the attachment hole 12.

Further, the entire protrusion forming region 14a may be the protrusion 14a1. For example, the protrusion forming region 14a may be formed as an inclined surface that protrudes toward the inside of the attachment hole 12 from one end (for example, a lower end) to the other end (for example, an upper end) in the z-axis direction of the protrusion forming region 14a.

In the present embodiment, the protrusion 14a1 is long in the circumferential direction of the peripheral wall 14 (a direction that goes around the peripheral wall 14 orthogonal to the depth direction of the attachment hole 12), and extends along the direction. That is, the protrusion 14a1 extends in a direction intersecting the depth direction of the attachment hole 12. The protrusion 14a1 need not extend in the circumferential direction of the peripheral wall 14. For example, the protrusion 14al may extend in a spiral direction inclined to the same extent as a spiral groove 211 of the shaft member 210 to be described later with respect to the circumferential direction.

Since the protrusion 14al extends in the direction intersecting the depth direction of the attachment hole 12, when the shaft member 210 is inserted into the attachment hole 12, the protrusion 14a1 comes into pressure contact with the side surface of the shaft member 210 by a surface or a line extending in the direction intersecting the axial direction of the shaft member 210. Thus, even if the shaft member 210 tries to move in the depth direction of the attachment hole 12 (axial direction of the shaft member 210), the shaft member 210 can be sufficiently held by the protrusion 14a1.

The electronic component holder 100 in the present embodiment includes a case portion 20. The case portion 20 is a member that encloses at least a part of the electronic component. In the present embodiment, the case portion 20 has a bottomed recess (electronic component housing recess 21) that has an opening 21a on the surface of the case portion 20 and into which an electronic component is inserted. Specifically, the case portion 20 has an electronic component housing recess 21 having an opening 21a on a side surface facing the side (particularly, one side in the x-axis direction). Hereinafter, a direction from the bottom portion of the electronic component housing recess 21 toward the opening 21a may be referred to as an opening direction. The electronic component is inserted into the electronic component housing recess 21 through the opening 21a and housed in the case portion 20. After the electronic component is stored in the electronic component housing recess 21, the opening 21a may be closed by a lid portion (not shown).

Instead of the present embodiment, the opening 21a in the electronic component housing recess 21 may be opened in either the y-axis direction or the z-axis direction.

In the present embodiment, the case portion 20 is integrally formed of the same material as the flange portion 10, but is not limited thereto. The case portion 20 and the flange portion 10 may be formed of another member and connected by adhesion, engagement, or the like.

In addition, instead of the present embodiment, the electronic component holder 100 may not include the case portion 20 that encloses the electronic component. For example, the electronic component may be attached to the base portion 10 in an exposed state.

The electronic component holder 100 of the present embodiment further includes a connector portion 30. An external plug is attached to the connector portion 30 by insertion or the like, and an external device such as a control device and the electronic component are connected via the plug. In the present embodiment, the connector portion 30 has a bottomed recess (not shown in the drawings) that opens in a direction (x direction) opposite to the opening direction (−x direction) of the electronic component housing recess 21. The external plug is inserted into the recess. The recess communicates with the electronic component housing recess 21 through a hole also received in the bottom, and the plug can be connected to the electronic component housed in the electronic component housing recess 21 through the hole.

In the present embodiment, the connector portion 30 is integrally formed of the same material as the case portion 20, but the case portion 20 and the connector portion 30 may be formed as separate members and connected by adhesion, engagement, or the like.

The shaft member 210 is a member that is long in the axial direction and is inserted into the attachment hole 12. In the present embodiment, the shaft member 210 is a metal bolt, but is not limited thereto. The shaft member 210 may be a rod-shaped member formed of a material other than metal, and may be made of resin, for example.

The fact that the cross section of the shaft member 210 is circular means that a cross section (end surface) obtained by cutting the shaft member 210 in an axis orthogonal direction is substantially circular. When the shaft member 210 is described as “cross section” without any description, it means a cross section. A cross section of the shaft member 210 is not limited to a perfect circular shape. For example, when a spiral groove is formed on the side surface of the shaft member 210 as described later, the cross section of the shaft member 210 may not be a perfect circle. Further, the outer edge of the cross section of the shaft member 210 does not need to smoothly continue, and may have a corner, for example, at the end point of the spiral. It is sufficient that the cross section has a circular shape to such an extent that the widths of the shaft member 210 in a plurality of arbitrary directions in the lateral direction (axis orthogonal direction) are equal to each other.

As shown in FIG. 6B, a spiral groove (hereinafter, referred to as a spiral groove 211) is formed on the entire side surface of the shaft member 210 in the present embodiment. Although an extending direction (hereinafter, also referred to as a spiral direction) of the spiral groove 211 is slightly inclined with respect to the circumferential direction of the shaft member, the spiral direction of the spiral groove 211 and the circumferential direction of the shaft member 210 approximately coincide with each other. An engagement groove 212 described later is a partial length region of the spiral groove 211.

The side surface of the shaft member 210 is a peripheral surface of the shaft member 210, and is a surface extending in the axial direction and the circumferential direction of the shaft member 210. A wall portion and a bottom portion constituting the spiral groove 211 and the engagement groove 212 constitute a part of the side surface of the shaft member 210.

In the present embodiment, the shaft member 210 is welded to the installation surface 200 as described later, but the shaft member 210 may be formed integrally with the installation surface 200 in advance. That is, the shaft member 210 may be a part of the installation surface 200. In the shaft member 210, one end connected to the installation surface 200 may be referred to as a proximal end, and one end opposite to the proximal end may be referred to as a distal end.

As described above, a distance between the protrusion 14a1 and the center of the attachment hole 12 is smaller than the radius of the shaft member 210 as viewed in the z-axis direction. The distance between the protrusion 14al and the center of the attachment hole 12 as viewed from the z-axis direction is the shortest distance between the protrusion 14al and the center of the attachment hole 12 in a natural state before the shaft member 210 is inserted (a state in which the attachment hole 12 is not expanded by the shaft member 210 as described later). The center of the attachment hole 12 having a rectangular shape like the first attachment hole 12a in the present embodiment is a center line bisecting the short direction (a line connecting points equidistant from two sides facing each other in the short direction among four sides constituting the first attachment hole 12a). That is, a distance between the center line of the first attachment hole 12a and the top portion of the protrusion 14a1 is smaller than the radius of the shaft member 210. When the attachment hole 12 has a regular polygon shape, the center point of the regular polygon is the center of the attachment hole 12, and when the shape of the attachment hole 12 is a triangle like the second attachment hole 12b, the inner center of the triangle is the center of the attachment hole 12 as described later.

As described later, the shaft member 210 is inserted into the attachment hole 12 in a direction in which the axial direction of the shaft member 210 coincides with the depth direction of the attachment hole 12. The shaft member 210 is inserted into the attachment hole 12 so deeply that the side surface of the shaft member 210 and the protrusion 14al are in contact with each other. A state in which the shaft member 210 is inserted into the attachment hole 12 and the protrusion 14a1 is in pressure contact with the side surface of the shaft member 210 is referred to as an attached state.

As described above, since the distance between the protrusion 14a1 and the center of the attachment hole 12 is smaller than the radius of the shaft member 210, the peripheral wall of the attachment hole 12 through which the shaft member 210 is inserted into the attachment hole 12 is pushed to the outside of the attachment hole 12 by the side surface of the shaft member 210, and the attachment hole 12 is expanded by the shaft member 210. As a result, in the attached state, the protrusion 14a1 (particularly, the top portion) is in pressure contact with the side surface of the shaft member 210 in a direction toward the axial center of the shaft member 210. More specifically, in the attached state, the top portion of the protrusion 14al and one or a plurality of facing portions described later are in pressure contact with the side surface of the shaft member 210. The shaft member 210 is biased by the peripheral wall 14 (the protrusion 14a1 and the facing portion 14b) at two or more positions facing each other with the attachment hole 12 interposed therebetween, so that the peripheral wall 14 holds the shaft member 210 at a predetermined position. That is, the relative positional relationship between the shaft member 210 and the attachment hole 12, and the relative positional relationship between the shaft member 210 and the electronic component holder 100 are fixed.

In the present embodiment, a part of the base portion 10 is a leaf spring portion 11 extending along the periphery of the attachment hole 12. A pressed surface (attachment hole facing surface 14c) of the leaf spring portion 11 is a part of the peripheral wall 14. Here, the pressed surface of the leaf spring portion 11 is a surface of the leaf spring portion 11 that is pressed and expanded by the shaft member 210 inserted into the attachment hole 12. The leaf spring portion 11 of the present embodiment has a thin plate shape, and one of a pair of main surfaces facing the inside of the attachment hole 12 is a pressed surface. Both ends of the leaf spring portion 11 in the extending direction of the leaf spring portion 11 are formed continuously with an adjacent portion 13 of the base portion 10 adjacent to the leaf spring portion 11. A central portion of the leaf spring portion 11 in the extending direction of the leaf spring portion 11 is separated from another part of the base portion 10 (the entire base portion 10 excluding the leaf spring portion 11, also referred to as a leaf spring outer portion). The leaf spring portion 11 can be bent so that the intermediate portion of the leaf spring portion 11 is displaced toward the center of the attachment hole 12 or opposite to the center of the attachment hole 12.

The leaf spring portion 11 can be bent in a direction intersecting (orthogonal to) the extending direction of the leaf spring portion 11 by applying an external force, and has a restoring force to return to a natural state (a state in which no external force is applied and there is no bending) in a bent state. Thus, in the attached state in which the shaft member 210 is inserted into the attachment hole 12, the leaf spring portion 11 is more favorably brought into pressure contact with the side surface of the shaft member 210 by the elastic restoring force of the leaf spring portion 11, and the shaft member 210 is firmly gripped by the leaf spring portion 11 and the facing portion 14b to be described later.

Here, the leaf spring portions 11 has a higher ease of elastic deformation in a direction away from the center of the attachment hole 12 (also referred to as outward) and a direction toward the center of the attachment hole 12 (also referred to as inward and also referred to as an inward and outward direction together with the outward direction) than in other directions orthogonal to the inward and outward directions. The leaf spring portion 11 is a member having a spring property that elastically deforms flexibly in the inward and outward directions.

As shown in FIG. 5A, the leaf spring portion 11 is long along the periphery of the attachment hole 12, and both ends in the extending direction of the leaf spring portion 11 are continuous with the adjacent portion 13 which is a part of the base portion 10 and adjacent to a proximal end portion of the leaf spring portion 11. The leaf spring portion 11 is connected to the leaf spring outer portion of the base portion 10 only at both ends in the extending direction of the leaf spring portion 11. In other words, as described above, the intermediate portion in the extending direction of the leaf spring portion 11 is separated from the leaf spring outer portion (for example, a facing portion 14b to be described later or a through hole facing portion 16 to be described later). That is, in the leaf spring portion 11, both end portions connected to the adjacent portion 13 are fixed, and the intermediate portion can freely move. In other words, the leaf spring portion 11 is a member supported at both ends by the base portion 10 (adjacent portion 13), and its intermediate portion is capable of bending in a predetermined direction (in this embodiment, direction of the thickness of the leaf spring portion 11). When an external force in a direction orthogonal to the extending direction of the leaf spring portion 11 is applied to the intermediate portion, the leaf spring portion 11 bends in an arcuate manner so that the intermediate portion (particularly, a part to which the external force is applied) moves outward with both end portions of the leaf spring portion 11 as fulcrums. Hereinafter, a direction in which the leaf spring portion 11 is bent (a direction in which the intermediate portion of the leaf spring portion 11 is displaced) is referred to as a bending direction.

Here, the fact that the leaf spring portion 11 can be bent means that the intermediate portion of the leaf spring portion 11 is displaced from the natural state by a force of an extent of manually inserting the shaft member 210 into the attachment hole 12, the leaf spring portion 11 becomes arcuate, and the protrusion 14al is brought into a pressure contact state with the shaft member 210. That is, the leaf spring portion 11 has sufficient flexibility to insert the shaft member 210 into the attachment hole 12, and has sufficient flexibility to bring the protrusion 14a1 into pressure contact with the shaft member 210. In the peripheral wall of the through hole (3fb) in JP 2016-100610 A, one end in the depth direction of the through hole (3fb) is connected to a part of the flange portion (3f) (specifically, a bottom portion of a carved-out recess received also in the flange portion (3f)), and the peripheral wall of the through hole (3fb) does not have a sufficient spring property and is rigid. That is, the peripheral wall of the through hole (3fb) in JP 2016-100610 A cannot be bent like the leaf spring portion 11.

The dimension of the leaf spring portion 11 in the extending direction of the leaf spring portion 11 is preferably equal to or larger than a diameter of the shaft member 210. More preferably, the dimension of the leaf spring portion 11 in the extending direction of the leaf spring portion 11 is 1.5 times or larger than the diameter of the shaft member 210. Since the leaf spring portion 11 is sufficiently long in the extending direction of the leaf spring portion 11, the leaf spring portion 11 has sufficient flexibility.

The dimension of the leaf spring portion 11 in the extending direction of the leaf spring portion 11 is preferably smaller than three times the diameter of the shaft member. In other words, in the attached state, a distance between the side surface of the shaft member 210 and the peripheral wall 14 is preferably smaller than the diameter of the shaft member 210. Specifically, as shown in FIG. 5A, in the first attachment hole 12a having a horizontally long rectangular shape, a distance in the x-axis direction between the peripheral wall facing in the x-axis direction and the side surface of the shaft member 210 is smaller than the diameter of the shaft member 210. In the triangular second attachment hole 12b, a distance between the side surface of the shaft member 210 and a part of the peripheral wall 14 corresponding to a vertex of the triangle is smaller than the diameter of the shaft member 210. As described above, since the shaft member 210 and the peripheral wall 14 are not largely separated from each other and the leaf spring portion 11 is not excessively long, the central portion (portion in pressure contact with the shaft member) of the leaf spring portion 11 can be in pressure contact with the shaft member 210 with a sufficient force for gripping the shaft member 210.

In the present embodiment, the leaf spring portion 11 is linear. Since the leaf spring portion 11 is linear, the leaf spring portion 11 can be easily bent in the middle thereof. Here, the linear shape is not limited to a perfect linear shape, and may be slightly curved. Instead of the present embodiment, the leaf spring portion 11 may have an arc shape or a wave shape having an uneven shape as a whole.

As shown in FIG. 6B, in the present embodiment, a lower surface of the leaf spring portion 11 is disposed on the same plane as the lower surface of the flange portion 10, but is not limited thereto. The lower surface of the leaf spring portion 11 may be disposed on the inner side (upper side) of the flange portion 10 with respect to the lower surface of the flange portion 10. In this case, the lower surface of the leaf spring portion 11 is not in contact with the installation surface 200 in the attached state, and the bending of the leaf spring portion 11 is not hindered by the friction between the leaf spring portion 11 and the installation surface 200.

The leaf spring portion 11 is preferably a plate-like member in which a part of the pressed surface facing the attachment hole 12 (attachment hole facing surface 14c to be described later) is a main surface, and the main surface is larger than the side surface. Specifically, it is preferable that a dimension (hereinafter, also referred to as a width dimension of the leaf spring portion 11) of the leaf spring portion 11 in the direction (bending direction, the y-axis direction in the first attachment hole 12a) orthogonal to the pressed surface (attachment hole facing surface 14c) of the leaf spring portion 11 that is a part of the peripheral wall 14 is smaller than a dimension of the leaf spring portion 11 in the depth direction (z-axis direction) of the attachment hole 12. In such a leaf spring portion 11, the bending direction of the leaf spring portion 11 can be said to be a direction perpendicular to the plane of the leaf spring portion 11 (in particular, the main surface). When the cross section of the leaf spring portion 11 is rectangular as in the present embodiment, as shown in FIG. 6B, the z-axis direction is the longitudinal direction of the rectangular cross section, and the lateral direction is the lateral direction of the rectangular cross section. Unlike the present embodiment, when the cross section of the leaf spring portion 11 has another flat shape (for example, an elliptical shape), the largest dimension in the z-axis direction in the cross section is larger than the largest dimension in the lateral direction.

Since the leaf spring portion 11 is thin in the bending direction, the leaf spring portion 11 can have sufficient flexibility for bending. In addition, since the dimension of the leaf spring portion 11 in the z-axis direction is large, the elasticity of the leaf spring portion 11 is large as compared with the case where the dimension of the leaf spring portion 11 in the z-axis direction is small, and the restoring force for returning from a bent state to a natural state is large. That is, in the attached state, the leaf spring portion 11 (in particular, the protrusion 14a1) comes into pressure contact with the shaft member with a stronger force.

In the present embodiment, the dimension in the bending direction is smaller than the dimension in the z-axis direction over the entire length in the extending direction of the leaf spring portion 11, but is not limited thereto. The dimension in the bending direction may be smaller than the dimension in the z-axis direction only in a partial length region in the extending direction of the leaf spring portion 11. That is, only a partial length region of the long member may have sufficient flexibility and function as the leaf spring portion 11. It is desirable that an intermediate portion of the long member in which at least the protrusion 14a1 is provided has a dimension in the bending direction smaller than a dimension in the z-axis direction and functions as the leaf spring portion 11.

Instead of the present embodiment, when the flange portion 10 is thin, the dimension of the leaf spring portion 11 in a direction orthogonal to the pressed surface of the leaf spring portion 11 which is a part of the peripheral wall 14 may be larger than a dimension of the leaf spring portion 11 in the depth direction of the attachment hole 12. For example, the area of the surface (end surface) of the leaf spring portion 11 oriented in the z-axis direction may be larger than the area of the pressed surface of the leaf spring portion 11 which is a part of the peripheral wall 14. With this configuration, since the leaf spring portion 11 has a sufficiently large dimension in the bending direction, it is possible to prevent the leaf spring portion 11 from being accidentally broken when the leaf spring portion 11 is bent. Even in such a configuration, the leaf spring portion 11 has sufficient flexibility for inserting the shaft member 210 into the attachment hole 12.

As shown in FIG. 5A, the facing portion 14b which is a part of the peripheral wall 14 faces the pressed surface (attachment hole facing surface 14c) of the leaf spring portion 11 across the attachment hole 12. At least a part of the attachment hole facing surface 14c of the leaf spring portion 11 is a forming region of the protrusion (protrusion forming region 14a). In other words, the facing portion 14b faces the protrusion forming region 14a including the protrusion 14a1. The facing portion 14b is a non-forming region of the protrusion 14a1.

As described later, when the shaft member 210 is inserted into the attachment hole 12, the peripheral wall 14 is expanded while the shaft member 210 pushes the protrusion 14a1 outward. Since the protrusion 14a1 is provided in the leaf spring portion 11 having flexibility, when the protrusion 14a1 is pushed outward by the insertion of the shaft member 210, the leaf spring portion 11 including the protrusion 14a1 is bent, and the attachment hole 12 is easily widened as much as the shaft member 210 can be inserted. As compared with a case where the protrusion 14a1 is provided in a portion other than the leaf spring portion 11 (a portion having lower flexibility than the leaf spring portion 11), the shaft member 210 can be easily inserted into the attachment hole 12. Further, when the protrusion 14a1 is pushed, the leaf spring portion 11 including the protrusion is bent, so that the protrusion 14al is prevented from being damaged by the force of the shaft member 210 pushing the protrusion 14a1.

Since the facing portion 14b does not have the protrusion 14a1 and is a flat surface at least in the z-axis direction, the side surface of the shaft member 210 and the peripheral wall 14 (facing portion 14b) are brought into pressure contact with each other at a plurality of points continuous in the z-axis direction as described later, and the peripheral wall 14 can grip the shaft member 210 more firmly. Further, since the peripheral wall 14 supports the shaft member 210 at a plurality of places continuous in the z-axis direction, it is possible to prevent the shaft member 210 from being inclined with respect to the depth direction of the attachment hole 12 in the attached state.

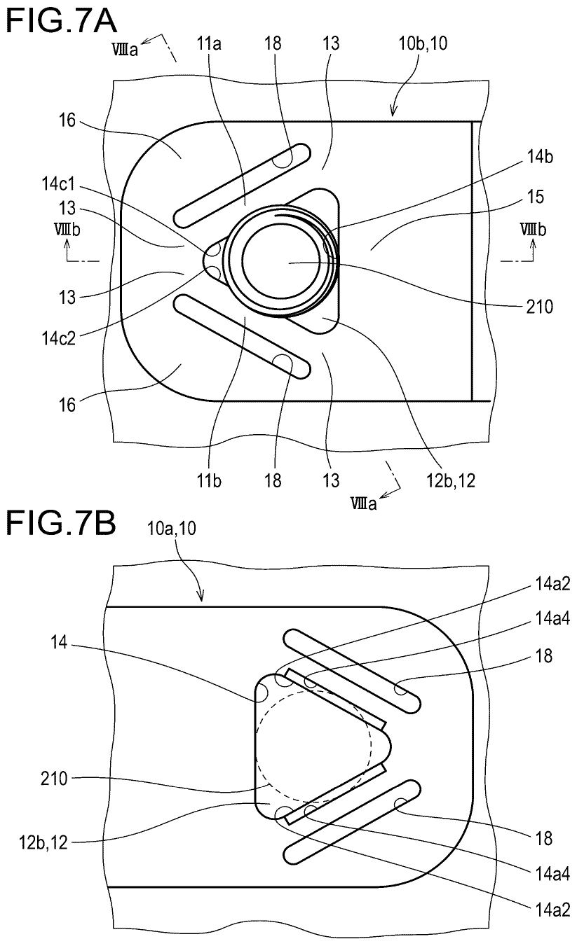

The facing portion 14b is a part of the peripheral wall 14 that faces the leaf spring portion 11 (particularly, an intermediate portion thereof) with the attachment hole 12 interposed therebetween. As described later, when the shaft member 210 is inserted into the attachment hole 12, the side surface of the shaft member 210 is in contact with the facing portion 14b. The facing portion 14b is preferably a gently curved surface or a flat surface. For example, as shown in FIG. 5A, the first attachment hole 12a has a horizontally long rectangular shape, but the facing portion 14b is a part of the peripheral wall 14 that faces the attachment hole facing surface 14c by 180 degrees and extends in the longitudinal direction (x-axis direction). As shown in FIG. 7A, the second attachment hole 12b has an equilateral triangle shape and has two leaf spring portions 11a and 11b. The facing portion 14b that faces the attachment hole facing surface 14cl in the leaf spring portion 11a of the second attachment hole 12b is a portion facing the attachment hole facing surface 14c at 120 degrees with the attachment hole 12 interposed therebetween, and specifically, is one flat portion constituting an equilateral triangle of the peripheral wall 14. Note that, when the leaf spring portion 11b is not provided, a flat portion corresponding to an attachment hole facing surface 14c2 in the leaf spring portion 11b in FIG. 7A may also be the facing portion 14b.

As described above, the entire attachment hole facing surface 14c may be the protrusion forming region 14a, and only a part of the attachment hole facing surface 14c may be the protrusion forming region 14a. The protrusion 14al may be formed at least in a middle region of the attachment hole facing surface 14c in the extending direction of the leaf spring portion 11 (particularly, a portion with which the shaft member 210 comes into contact or approaches in the attached state).

The facing portion 14b being a non-forming region of the protrusion 14a1 means that the non-forming region is a surface having substantially no unevenness. That is, as described above, the facing portion 14b is a substantially flat surface or a gently curved surface. The gently curved surface means that it is gentler than the arc shape of the outer edge of the shaft member 210.

As shown in FIG. 6B, in the attached state, the side surface of the shaft member 210 and the facing portion 14b are in contact with each other at a plurality of positions continuous in the z-axis direction. Specifically, the end portion (the outermost end portion in the radial direction of the shaft member 210) of the wall portion forming the spiral groove 211 formed in the side surface of the shaft member 210 and the facing portion 14b are in contact with each other. Instead of the present embodiment, the side surface of the shaft member 210 and the facing portion 14b may be in substantial line or surface contact with each other. At this time, a contact surface (or a substantial line) between the side surface of the shaft member 210 and the facing portion 14b is along the z-axis direction. For example, when the spiral groove 211 is not provided in the shaft member 210, or when the shaft member 210 and the facing portion 14b are in pressure contact with each other so that the side surface of the shaft member 210 bites into the spiral groove 211, the side surface of the shaft member 210 and the facing portion 14b are substantially in line or plane contact with each other.

As shown in FIG. 5A, the base portion 10 includes a facing wall portion 15 which includes the facing portion 14b and is positioned on a side away from the center of the attachment hole 12. The dimension (width dimension) of the facing wall portion 15 in the direction orthogonal to the facing portion 14b is larger than the dimension (width dimension of the leaf spring portion 11) of the leaf spring portion 11 in the direction orthogonal to the pressed surface (attachment hole facing surface 14c). More preferably, the width dimension of the facing wall portion 15 is larger than the dimension of the facing wall portion 15 in the z-axis direction. That is, the facing wall portion 15 is a non-forming region of the leaf spring portion 11, and the facing wall portion 15 is a rigid member having substantially no flexibility to bend outward from the center of the attachment hole 12.

The facing wall portion 15 is a part of the base portion 10 including the facing portion 14b and up to the outer edge of the base portion 10. That is, the width dimension of the facing wall portion 15 refers to a distance from the facing portion 14b to the outer edge of the base portion 10. For example, as shown in FIG. 5A, in the first attachment hole 12a, a shortest distance from the facing portion 14b to the edge of the flange portion 10 located on a lower side of the facing portion 14b in the plane of drawing is the width dimension of the facing wall portion 15. Further, as shown in FIG. 7A, in the second attachment hole 12b, a shortest distance from the facing portion 14b to the proximal end of the flange portion 10 (the boundary between the flange portion 10 and the case portion 20) is the width dimension of the facing wall portion 15. Unlike the present embodiment, when the second attachment hole 12b is disposed on the more proximal end side of the flange portion 10 (the right side in FIG. 7A) than the present embodiment, the dimension of a part of the case portion 20 (a part of the case portion 20 on the flange portion 10 side) may also be included in the width dimension of the facing wall portion 15. This is because, as described above, a part of the case portion 20 on the flange portion 10 side is located near the second attachment hole 12b, and this part is also the base portion 10.

Since the facing wall portion 15 is rigid, the shaft member 210 can be firmly gripped by the leaf spring portion 11 and the facing wall portion 15. Further, since the facing wall portion 15 is rigid and does not deform, the electronic component holder 100 is disposed so that the facing wall portion 15 is in contact with the side surface of the shaft member 210 in the attached state. Thus, the shaft member 210 and the electronic component holder 100 can be fixed in a desired positional relationship at least in a direction orthogonal to the facing portion 14b.

As shown in FIG. 5A, the base portion 10 has a through hole 18 provided in the vicinity of the attachment hole 12 along a part of the peripheral wall 14. The part of the peripheral wall 14 along which the through hole 18 extends is a pressed surface (attachment hole facing surface 14c) of the leaf spring portion 11 facing the attachment hole 12. In the present embodiment, the through hole 18 is formed along one of the flat portions of the peripheral wall 14 defining the polygonal attachment hole 12. For example, the through hole 18 provided in the first flange portion 10a is formed along a flat portion of the peripheral wall 14 forming a long side of the first attachment hole 12a having a horizontally long rectangular shape.

The leaf spring portion 11 is disposed between the attachment hole 12 and the through hole 18. That is, a part of the base portion 10 formed between the attachment hole 12 and the through hole 18 serves as the leaf spring portion 11. Arranging the through hole 18 and the attachment hole 12 in the vicinity means that a part of the base portion 10 sandwiched between the through hole 18 and the attachment hole 12 is sufficiently close to have flexibility as the leaf spring portion 11. Specifically, a distance between the attachment hole 12 and the through hole 18 (the width dimension of the leaf spring portion 11) is preferably smaller than the dimension of the leaf spring portion 11 in the depth direction of the attachment hole 12.

When the through hole 18 is provided, as compared with the case where a peripheral edge portion of the flange portion 10 is the leaf spring portion 11 without providing the through hole 18 as described in the modification described later, even if the leaf spring portion 11 is accidentally damaged, the electronic component holder 100 can be prevented from completely detaching from the attachment destination member. Specifically, for example, when the leaf spring portion 11 is lost due to breakage, it is difficult to hold the shaft member 210 by the leaf spring portion 11 and the facing portion, but the shaft member 210 is still surrounded by the inner wall of the flange portion 10 defining the attachment hole 12 and the through hole 18. Therefore, the shaft member 210 is prevented from completely coming off from the attachment hole 12.

A dimension in a direction orthogonal to the extending direction of the through hole 18 in a part of the base portion 10 (the through hole facing portion 16 shown in FIG. 5A) facing the leaf spring portion 11 with the through hole 18 interposed therebetween is preferably larger than the width dimension of the leaf spring portion 11. Since rigidity of the part of the leaf spring portion 11 in the bending direction is larger than rigidity of the leaf spring portion 11 in the bending direction, even when the leaf spring portion 11 is accidentally lost as described above, it is possible to prevent the shaft member 210 from being detached from the flange portion 10 due to the loss of the part.

In the present embodiment, the through hole 18 is long in the extending direction of the leaf spring portion 11. The extending direction of the leaf spring portion 11 and the extending direction of the through hole 18 are preferably the same direction. A width of the through hole 18 (dimension in a direction orthogonal to the depth direction of the attachment hole 12 and the extending direction of the through hole 18) is smaller than a dimension of the leaf spring portion 11 (width dimension of the leaf spring portion 11) in a direction orthogonal to the attachment hole facing surface 14c. Further, a width dimension of the through hole 18 is preferably larger than the amount by which the leaf spring portion 11 is displaced in the bending direction in the attached state. In the present embodiment, the width of the through hole 18 is larger than the protrusion height of the protrusion 14a1 (the height of the top surface 14a2 with respect to the recessed surface 14a4).

By limiting the width of the through hole 18 to be small, it is possible to prevent the leaf spring portion 11 from being excessively bent and damaged beyond its own flexibility. This is because even if the leaf spring portion 11 attempts to bend excessively, the leaf spring portion 11 abuts on the through hole facing portion 16, and the leaf spring portion 11 cannot bend more largely than the width of the through hole 18 in the bending direction.

Furthermore, by reducing the width of the through hole 18, the flange portion 10 can be reduced.

Instead of the present embodiment, the width dimension of the through hole 18 may be larger than the width dimension of the leaf spring portion 11. In this case, since the through hole 18 has a large dimension in the bending direction of the leaf spring portion 11, the leaf spring portion 11 can be greatly bent. That is, even when the distance between the center of the attachment hole 12 and the protrusion 14a1 is made sufficiently smaller than the radius of the shaft member 210, and the leaf spring portion 11 is largely bent to grip the shaft member 210 with a stronger force, the leaf spring portion 11 and the through hole facing portion 16 do not interfere with each other.

As shown in FIGS. 6A and 6B, a top portion of the protrusion 14a1 protruding most toward the inside of the attachment hole 12 is a flat top surface 14a2 extending in the depth direction of the attachment hole 12. That is, the protrusion 14a1 has a thickness of a predetermined dimension (dimension of the top surface 14a2 in the depth direction of the attachment hole 12) or more in the depth direction of the attachment hole 12. In the attached state, the top surface 14a2 faces the side surface of the shaft member 210. When the shaft member 210 is inserted into the attachment hole 12, it is rubbed against the shaft member 210, so that the protrusion 14al may be worn, that is, the protrusion 14a1 may become thin in the depth direction of the attachment hole 12. Since the protrusion 14a1 has a predetermined dimension in the depth direction of the attachment hole 12, even if the protrusion 14a1 wears due to the shaft member 210 being inserted into the attachment hole 12, the protrusion 14a1 can have a sufficient protruding height to be in pressure contact with the shaft member 210.

Instead of the present embodiment, the top portion of the protrusion 14al may be a corner portion. That is, the top portion may be a substantial line along the circumferential direction of the peripheral wall 14. When the top portion is a corner portion, it is possible to make pressure contact so as to bite into the side surface of the shaft member 210 (particularly, a bottom portion 212b of the engagement groove 212).

As shown in FIG. 6B, the side surface of the shaft member 210 is provided with a bottomed groove portion (engagement groove 212) that engages with the protrusion 14a1 when the shaft member 210 is inserted into the attachment hole 12. The dimension of the top surface 14a2 in the depth direction of the attachment hole 12 (the width dimension of the top surface 14a2) is larger than the width of the bottom portion 212b of the engagement groove 212 in the axial direction of the shaft member 210. The engagement groove 212 is a groove provided on the side surface of the shaft member 210 to engage with the protrusion 14a1 in the attached state. In the present embodiment, a partial length region of the spiral groove 211 is the engagement groove 212. Specifically, in the spiral groove 211, a partial length region facing the protrusion 14a1 in the attached state is the engagement groove 212. As will be described later, the engagement groove 212 may extend in a direction intersecting the axial direction of the shaft member 210 and have a constant length, or may be a short groove.

As shown in FIG. 6C, the engagement groove 212 is defined by the bottom portion 212b and a pair of wall portions facing each other in the axial direction of the shaft member 210. In the present embodiment, the bottom portion 212b of the engagement groove 212 has a planar shape having a certain dimension in the axial direction of the shaft member 210, but the bottom portion 212b may have a linear shape without having a substantial length in the axial direction of the shaft member 210.

Since the width dimension of the top surface 14a2 is larger than the width of the bottom portion of the engagement groove 212, the protrusion 14a1 comes into pressure contact with each of the pair of wall portions defining the engagement groove 212 in the attached state as described later. Thus, the shaft member 210 can be more firmly gripped by the protrusion 14al and the facing portion 14b. Further, since the protrusion 14a1 is in pressure contact with both of the pair of wall portions facing each other in the depth direction of the attachment hole 12, the shaft member 210 and the electronic component holder 100 are prevented from being relatively displaced in the z-axis direction in the attached state.

Instead of the present embodiment, the width dimension of the top surface 14a2 may be equal to or smaller than the width of the bottom portion 212b of the engagement groove 212. In this case, in the attached state, the top surface 14a2 and the bottom portion 212b of the engagement groove 212 may be in pressure contact with each other. In this case, since the contact surface between the protrusion 14a1 and the side surface of the shaft member 210 becomes large, the relative positional relationship between the shaft member 210 and the electronic component holder 100 is prevented from being deviated in the z-axis direction by friction of the contact surface.

The engagement groove 212 extends in a direction intersecting the axial direction of the shaft member 210. In the present embodiment, the engagement groove 212 extends in the spiral direction of the spiral groove 211. Alternatively, the engagement groove 212 may extend in a direction orthogonal to the axial direction of the shaft member 210. At least one wall portion (pressure contact wall portion 212c) of the two wall portions forming the engagement groove 212 so as to sandwich the engagement groove 212 in the axial direction of the shaft member 210 is inclined with respect to the axial direction of the shaft member 210. Among the pair of wall portions, at least a wall portion (lower wall portion in the present embodiment) close to the attachment destination member (installation surface 200) is preferably inclined with respect to the axial direction. In the present embodiment, both of the pair of wall portions are inclined with respect to the axial direction of the shaft member 210, but the lower wall portion is referred to as a pressure contact wall portion 212c.

The protrusion 14al has an inclined surface 14a3 that is inclined with respect to the depth direction of the attachment hole 12 and faces one wall portion when the shaft member 210 is inserted into the attachment hole 12. The inclined surface 14a3 is disposed between the top surface 14a2 and the recessed surface 14a4. An inclination of the inclined surface 14a3 in the protrusion 14a1 with respect to the depth direction of the attachment hole 12 is smaller than an inclination of one wall portion (pressure contact wall portion 212c) of the engagement groove 212 with respect to the axial direction of the shaft member 210. Here, the inclination of the inclined surface 14a3 with respect to the depth direction of the attachment hole 12 and the inclination of the pressure contact wall portion 212c with respect to the axial direction are angles that are acute angles among angles formed by each direction and each plane. Since the angle of the inclined surface 14a3 with respect to the depth direction of the attachment hole 12 is larger than the angle with respect to the axial direction of the pressure contact wall portion 212c, the pressure contact wall portion 212c and the inclined surface 14a3 interfere with each other in the attached state. That is, in the attached state, the pressure contact wall portion 212c and the inclined surface 14a3 are in surface contact with each other and are in pressure contact with each other. The entire pressure contact wall portion 212c may be in surface contact with the inclined surface 14a3, or only a part of the pressure contact wall portion 212c on the outer side may be in surface contact with the inclined surface 14a3. However, as described later, in FIGS. 6B and 6C, for convenience, the protrusion 14a1 is shown in a state of interfering with the side surface of the shaft member 210 without being deformed.

The shaft member 210 is prevented from being detached from the attachment hole 12 by friction between the pressure contact wall portion 212c and the inclined surface 14a3 due to pressure contact between the pressure contact wall portion 212c and the inclined surface 14a3 at the surfaces.

The protrusion 14al has an end surface 11c1 connected to the opposite side of the inclined surface 14a3 with respect to the top portion. The end surface 11c1 faces a direction different from the inclined surface 14a3 in the depth direction. The inclination of the end surface 11cl of the protrusion 14a1 with respect to the depth direction of the attachment hole 12 is larger than the inclination of the inclined surface 14a3 of the protrusion 14al with respect to the depth direction of the attachment hole 12. That is, surfaces (the end surface 11cl and the inclined surface 14a3) of the protrusion 14a1 respectively facing up and down directions are arranged at respective different angles with respect to the z-axis direction. Specifically, the inclined surface 14a3 is a gentle slope with respect to the recessed surface 14a4, and the end surface 11c1 stands upright with respect to the axial direction of the shaft member 210 in the attached state. Since the inclined surface 14a3 and the recessed surface 14a4 smoothly continue, it is easy to insert the shaft member 210 into the attachment hole 12. In addition, since the angle of the end surface 11c1 with respect to the axial direction of the shaft member 210 in the attached state is large, the protrusion 14al is prevented from being displaced from the engagement groove 212 to an upper side of the engagement groove 212, and the shaft member 210 is prevented from coming out of the attachment hole 12. The end face 11cl is a surface facing the upper side among the surfaces of the protrusion 14al. In the present embodiment, the end face 11c1 extends in a direction orthogonal to the z-axis direction, but may be inclined with respect to the z-axis direction. The inclination of the end surface 11c1 with respect to the depth direction of the attachment hole 12 refers to an angle that is an acute angle among angles formed by the direction and the plane.

As shown in FIG. 3, in the present embodiment, the attachment hole 12 has a polygonal shape. In the present embodiment, the first attachment hole 12a has a horizontally long rectangular shape. A length of one side (long side) of the attachment hole 12 is larger than a length of the other side, and the leaf spring portion 11 is formed including the one side (long side). By providing the leaf spring portion 11 along the long side, the length of the leaf spring portion 11 can be ensured sufficiently large, and the flexibility of the leaf spring portion 11 can be increased. The polygon is not limited to a triangle and a quadrangle (including a rectangle and a square), and may be a polygon having five or more corners. The shape of the attachment hole 12 is preferably a triangle or a quadrangle. This is because one side of a triangle or a quadrangle is longer than that of a polygon having five or more corners, and a long leaf spring portion 11 can be provided along the one side. Since the leaf spring portion 11 is long, the leaf spring portion 11 has large flexibility.

As shown in FIG. 4, the opening 21a is disposed on one side (upper side) of the base portion (the first flange portion 10a in the present embodiment) in the depth direction of the attachment hole 12. In addition, the attachment hole 12 is disposed outside the case portion 20 (on the right side in FIG. 4) in the direction from the bottom portion of the electronic component housing recess 21 toward the opening 21a. As shown in FIG. 6C, an outer surface (end surface 11c1) of the protrusion 14a1 facing one side (upper side) is flush with a main surface of the base portion facing one side (upper side). The outer surface of the protrusion 14a1 facing one side refers to a part of the surface of the protrusion 14a1 that can be visually recognized from above. Here, the two surfaces being flush means that the two surfaces are located on the same plane at substantially the same height. That is, the end surface 11c1 and an upper surface of the flange portion 10 (including a leaf spring portion upper surface 11c of the leaf spring portion 11) are located on the same plane at the same height in the z-axis direction. In other words, the attachment hole 12 is formed to have an equal width or a wide width downward from the upper surface of the flange portion 10, and is not formed to have a width that is narrower downward from the upper surface of the flange portion 10.

Since the upper surface of the flange portion 10 disposed on the opening side of the electronic component housing recess 21 is flush with the end surface 11c1, the electronic component holder 100 can be easily manufactured by resin injection molding. This is because the upper surface of the flange portion 10 is flush with and flat with the end surface 11c1, whereby the upper surface can be a sliding surface of a slide mold, and thus the electronic component housing recess 21 and the flange portion 10 can be molded by ae slide mold having a simple structure. Instead of the present embodiment, when the end surface 11c1 is not flush with the upper surface of the flange portion 10 and is formed to be recessed from the upper surface, the slide mold may be a multi-stage drive type, and the slide mold may be removed from the electronic component housing recess 21 after opening the mold that has formed the recessed end surface 11c1.

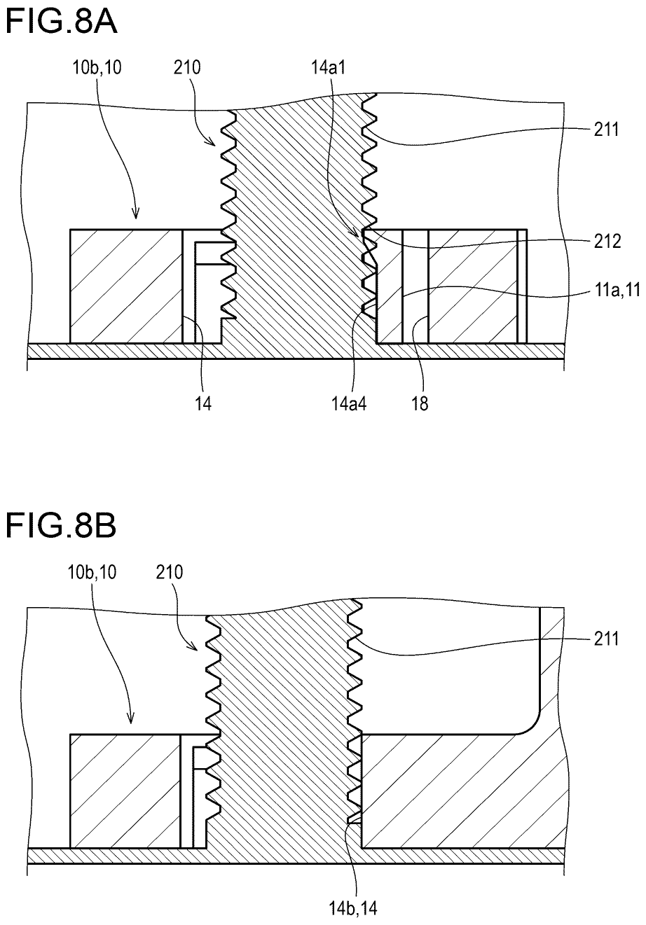

Hereinafter, the second flange portion 10b and the second attachment hole 12b will be described in detail with reference to FIGS. 7A to 8B. The second flange portion 10b has a leaf spring portion 11 and a through hole 18 having features similar to those of the first flange portion 10a described above. The second flange portion 10b is different from the first flange portion 10a in the shape of the attachment hole 12 as viewed from the z-axis direction and in that a plurality of (two) leaf spring portions 11 and through holes 18 is provided.

As described above, the second attachment hole 12b has an equilateral triangular shape when viewed from the z-axis direction. In the attached state, the shaft member 210 is in pressure contact with each plane portion constituting each side of an equilateral triangle of the peripheral wall 14 defining the second attachment hole 12b.

As shown in FIG. 8A, in the attached state, a part of the peripheral wall 14 facing the protrusion 14a1 provided in the leaf spring portion 11a at 180 degrees with the second attachment hole 12b interposed therebetween is not in contact with the side surface of the shaft member 210. As shown in FIG. 8A, the protrusion 14a1 is engaged with the engagement groove 212. The aspect of engagement between the protrusion 14a1 and the engagement groove 212 is similar to the aspect of engagement between the protrusion 14a1 and the engagement groove 212 in the first attachment hole 12a shown in FIG. 6C. As shown in FIG. 8B, a part of the peripheral wall 14 facing the facing portion 14b at 180 degrees with the second attachment hole 12b interposed therebetween is not in contact with the side surface of the shaft member 210.

In the second attachment hole 12b, the leaf spring portions 11 (leaf spring portions 11a and 11b) are provided along a part of the peripheral wall 14 forming at least two adjacent sides of the attachment hole 12. Each of the leaf spring portions 11a and 11b is provided with a protrusion 14a1. As viewed in the z-axis direction, a distance from each of the protrusions 14a1 to the center of the second attachment hole 12b (the inner center of a triangle in the present embodiment) is smaller than the radius of the shaft member 210. Therefore, both the leaf spring portions 11a and 11b are in pressure contact with the shaft member 210. Since the side surface of the shaft member 210 is biased in two directions (a direction orthogonal to an extending direction of the leaf spring portion 11a and a direction orthogonal to an extending direction of leaf spring portion 11b) by the two leaf spring portions 11, the shaft member 210 can be prevented from moving with respect to the second attachment hole 12b in the two directions.

In addition, the second flange portion 10b has a facing portion 14b opposed to the pressed surface of the leaf spring portion 11a or the leaf spring portion 11b. At least a part (all in the present embodiment) of the pressed surfaces of the leaf spring portion 11a and the leaf spring portion 11b is the protrusion forming region 14a, and the facing portion 14b is the protrusion non-forming region. Furthermore, the width dimension of the facing wall portion 15 which includes the facing portion 14b in the second flange portion 10b and is located on a side away from the center of the attachment hole 12 is larger than a width dimension of the leaf spring portion 11a or the leaf spring portion 11b.

Here, as described above, the facing portion 14b in the second attachment hole 12b is a surface of the peripheral wall 14 facing the pressed surfaces of the leaf spring portions 11a and 11b at 120 degrees with the second attachment hole 12b interposed therebetween.

Further, two through holes 18 are provided in the vicinity of the second attachment hole 12b. Each of the two leaf spring portions 11a and 11b is disposed between the second attachment hole 12b and the through hole 18.

Instead of the present embodiment, the shape of the second attachment hole 12b as viewed from the z-axis direction may be a square, and the leaf spring portion 11 may be provided on the peripheral wall 14 constituting two adjacent sides of the square. In this case, the electronic component holder 100 can be positioned with respect to the shaft member 210 in the bending direction of one leaf spring portion 11 and the bending direction of the other leaf spring portion 11, that is, in two orthogonal directions.

### (Electronic Component Holder)

The electronic component holder 100 according to the present embodiment can be provided only with the electronic component holder 100 without including the shaft member 210.

As described above, the electronic component holder 100 is a vehicle electronic component holder used together with the shaft member 210 having a circular cross section. The electronic component holder 100 has a base portion 10 provided with the attachment hole 12 for inserting the shaft member 210. The base portion 10 has the protrusion 14a1 protruding toward the inside of the attachment hole 12 from the peripheral wall 14 defining the attachment hole 12. By using the electronic component holder 100 together with the shaft member 210 described above, it is possible to attach the electronic component to the attachment destination member without labor of holding the electronic component holder at the time of screw fastening.

### (Method for Mounting Electronic Component)

Hereinafter, a method for attaching an electronic component to another member using the electronic component holder set of the present embodiment (hereinafter, the method may be referred to as the present method) will be described. Hereinafter, the method for attaching the electronic component may be described using a plurality of steps described in order, but the order described does not limit the order or timing of executing the plurality of steps.

Therefore, when the attachment method is performed, the order of the plurality of steps can be changed within a range in which there is no problem in terms of content, and a part or all of the execution timings of the plurality of steps may overlap each other.

As shown in FIG. 4, the shaft member 210 is attached by welding, bonding, or the like so as to protrude from the attachment destination member. In FIGS. 4, 6B, 8A, and 8B, a mode of joining the shaft member 210 and the installation surface 200 is not shown, and the shaft member 210 and the installation surface 200 are shown as the same member. When the plurality of attachment holes 12 is provided in the electronic component holder 100, the same number of shaft members 210 as the number of attachment holes 12 provided in the electronic component holder 100 are attached at positions spaced apart corresponding to the distance between the attachment holes 12. In the electronic component holder 100 of the present embodiment, since the two attachment holes 12 are provided, the two shaft members 210 are attached to positions separated from the installation surface 200.

An electronic component is inserted into the case portion 20 of the electronic component holder 100. The electronic component may be inserted into the case portion 20 before or after the electronic component holder 100 is attached to the installation surface 200.

The shaft member 210 is inserted into the attachment hole 12 in a state where the electronic component holder 100 maintains the inclination in which the axial direction of the shaft member 210 coincides with the depth direction of the attachment hole 12. As shown in FIG. 6B, in the present embodiment, the outer diameter of one end (tip) of the shaft member 210 is smaller than the lower width of the attachment hole 12. More specifically, the outer diameter of the tip of the shaft member 210 is smaller than the distance between the recessed surface 14a4 of the attachment hole 12 and a part of the peripheral wall 14 facing the recessed surface 14a4 at 180 degrees. In addition, the distal end portion of the shaft member 210 gradually increases in diameter from the most distal end toward the proximal end side. Thus, the shaft member 210 can be easily inserted into the attachment hole 12. In a case where the spiral groove 211 is formed on the side surface of the shaft member 210, the protrusion 14a1 is engaged with the spiral groove 211 in the process of the shaft member 210 being inserted into the attachment hole 12, and is repeatedly detached from the spiral groove 211. The shaft member 210 is inserted into the attachment hole 12 until the protrusion 14a1 is engaged with the engagement groove 212. In the attached state, the installation surface 200 and the lower surface of the flange portion 10 may be in contact with each other or may be partially separated from each other.

The method of attaching the electronic component to the installation surface 200 by the electronic component holder 100 and the shaft member 210 is not limited to the above-described method. For example, with the shaft member 210 attached to the electronic component holder 100 in advance, the shaft member 210 may be attached to the installation surface 200 by adhesion, engagement, or the like. Alternatively, with the electronic component holder 100 disposed on the installation surface 200, the shaft member 210 may be inserted into the attachment hole 12 and a screw hole provided in the installation surface 200.

In the attached state, the protrusion 14al and the engagement groove 212 are engaged. In FIG. 6C, the protrusion 14a1 and the side surface of the shaft member 210 are shown as interfering with each other, but actually, a part of the protrusion 14a1 or a part of the side surface of the shaft member 210 is scraped or deformed, and the pressure contact wall portion 212c and the inclined surface 14a3 are engaged in a pressure contact state.

In FIGS. 6B, 6C, and 8A, displacement of the leaf spring portion 11 in the bending direction is not shown in the drawings. In practice, the leaf spring portion 11 is displaced outward of the attachment hole 12 (rightward in the plane of drawing in FIG. 6B) when the protrusion 14a1 is biased by the side surface of the shaft member 210. In the present embodiment, since the protrusion 14a1 is provided at the upper end of the peripheral wall 14 as shown in FIG. 6B, in particular, an upper end portion of the leaf spring portion 11 is displaced rightward in the plane of drawing. A lower end portion of the leaf spring portion 11 may or may not be displaced rightward in the plane of drawing together with the upper end portion. Alternatively, when an upper end portion of the leaf spring portion 11 is displaced rightward, the leaf spring portion 11 may rotate with respect to the extending direction of the leaf spring portion 11, and the lower end portion of the leaf spring portion 11 may be displaced leftward in the drawing. In other words, in the attached state, the leaf spring portion 11 is inclined with respect to the axial direction of the shaft member 210 (the depth direction of the attachment hole 12). Specifically, the leaf spring portion 11 is inclined away from the shaft member 210 from the lower end toward the upper end of the shaft member 210. The lower end portion of the leaf spring portion 11 and the side surface of the shaft member 210 may be simply in contact with each other, may be in pressure contact with each other, or may be separated from each other. When the lower end portion of the leaf spring portion 11 is in contact with or pressed against the side surface of the shaft member 210, the base portion 10 is securely fixed to the shaft member 210 at both the upper and lower ends of the leaf spring portion 11. On the other hand, when the lower end portion of the leaf spring portion 11 is spaced apart from the side surface of the shaft member 210, sufficient room remains for the upper end portion of the leaf spring portion 11 (protrusion 14a1) to exert a biasing force against the shaft member 210. Therefore, the base portion 10 is securely fixed to the shaft member 210 in either case.

As described above, the extending direction of the protrusion 14a1 is the direction orthogonal to the z-axis direction (the circumferential direction of the peripheral wall 14), while the extending direction of the spiral groove 211 is not orthogonal to the z-axis direction. In the attached state, it is preferable that the protrusion 14a1 and the engagement groove 212 are in line or surface contact with each other by deformation or displacement of the protrusion 14a1 or the engagement groove 212.

In the present embodiment, the two attachment holes 12 are separated in the x-axis direction, and the first attachment hole 12a has a rectangular shape that is horizontally long in the x-axis direction as viewed in the z-axis direction. The distance between the two shaft members 210 may vary with respect to the distance between the two attachment holes 12 in the electronic component holder 100. When the plurality of attachment holes 12 is provided in the electronic component holder 100, the electronic component holder 100 can be attached to the attachment destination member even if the distance between the shaft members 210 varies by making one of the attachment holes 12 long in the separation direction in the separation direction between the attachment holes 12.

Note that the present invention is not limited to the above-described embodiments, and includes various modifications, improvements, and the like as long as the object of the present invention is achieved.

The following modifications can be appropriately combined.

Although the electronic component holder 100 in the present embodiment has the two attachment holes 12, the electronic component holder 100 may have only one attachment hole 12, or may have three or more attachment holes 12.

The leaf spring portion 11 may be provided at the peripheral edge portion of the flange portion 10. That is, a part of the peripheral wall 14 defining the attachment hole 12 may be close to and along the peripheral edge portion of the flange portion 10, and the peripheral edge portion of the flange portion 10 sandwiched between the peripheral edge of the flange portion 10 and a part of the peripheral wall 14 may be narrow to function as the leaf spring portion 11.

In the present embodiment, the protrusion 14a1 is provided only in a part of the peripheral wall 14 of the attachment hole 12, but is not limited thereto. The protrusion 14a1 may be formed over the entire circumference of the peripheral wall 14 of the attachment hole 12.

In the first attachment hole 12a, the leaf spring portion 11 may be further provided on the facing wall portion 15 facing the leaf spring portion 11. That is, the width dimension of the facing wall portion 15 may be reduced to such an extent as to have flexibility.

In the present embodiment, the leaf spring portion 11 is erected orthogonal to the lateral direction, that is, parallel to the longitudinal direction, but is not limited thereto. The leaf spring portion 11 may be inclined obliquely with respect to the longitudinal direction. Specifically, the leaf spring portion 11 may be inclined so as to fall toward the inside of the attachment hole 12.

In the attached state, a nut may be further fastened to the shaft member 210 (bolt), and the nut and the installation surface 200 may be brought into pressure contact with the flange portion 10. In this case, displacement of the flange portion 10 in the z-axis direction is prevented by the nut and the installation surface 200. As described above, the flange portion 10 is also prevented from being displaced in the lateral direction by being gripped by the protrusion 14a1 and the facing portion 14b. In a case where a general nut is tightened to a bolt and the flange portion 10 is gripped by the installation surface 200 and the nut, and in a case where the flange portion 10 is gripped by the screw head and the installation surface 200 as in JP 2016-100610 A, the flange portion 10 is deformed due to aging, and the force of gripping the flange portion 10 by the installation surface 200 and the nut (or the screw head) is weakened. As in the present embodiment, by gripping the shaft member 210 in the lateral direction by the flange portion 10, even if the gripping force of the flange portion 10 in the z-axis direction decreases, the relative positional relationship between the shaft member 210 and the electronic component holder 100 can be continuously maintained, and the electronic component holder 100 can be continuously held by the attachment destination member.

The above embodiment includes the following technical ideas.

(1) A vehicle electronic component holder set comprising: a shaft member having a circular cross section; and a vehicle electronic component holder, wherein
the vehicle electronic component holder includes a base portion provided with an attachment hole through which the shaft member is inserted,
the base portion includes a protrusion protruding from a peripheral wall defining the attachment hole toward an inside of the attachment hole,
a distance between the protrusion and a center of the attachment hole is smaller than a radius of the shaft member as viewed from a depth direction of the attachment hole, and
when the shaft member is inserted into the attachment hole, the protrusion comes into pressure contact with a side surface of the shaft member.

(2) The vehicle electronic component holder set according to (1), wherein
a part of the base portion is a leaf spring portion extending along a periphery of the attachment hole,
a pressed surface of the leaf spring portion is a part of the peripheral wall,
each of both ends of the leaf spring portion in an extending direction of the leaf spring portion is formed continuously with an adjacent portion of the base portion adjacent to the leaf spring portion,
a central portion of the leaf spring portion in the extending direction is separated from another part of the base portion, and
the leaf spring portion is bendable so that an intermediate portion of the leaf spring portion is displaced toward the center of the attachment hole or toward a direction opposite to the center of the attachment hole.

(3) The vehicle electronic component holder set according to (2), wherein a dimension of the leaf spring portion in a direction orthogonal to the pressed surface that is a part of the peripheral wall is smaller than a dimension of the leaf spring portion in the depth direction of the attachment hole.

(4) The vehicle electronic component holder set according to (2) or (3), wherein
a facing portion that is a part of the peripheral wall faces the pressed surface of the leaf spring portion across the attachment hole,
at least a part of the pressed surface of the leaf spring portion is a forming region of the protrusion, and
the facing portion is a non-forming region of the protrusion.

(5) The vehicle electronic component holder set according to any one of (2) to (4), wherein
a facing portion that is a part of the peripheral wall faces the pressed surface of the leaf spring portion across the attachment hole,
the base portion includes a facing wall portion that includes the facing portion and is located on a side away from the center of the attachment hole, and
a dimension of the facing wall portion in a direction orthogonal to the facing portion is larger than a dimension of the leaf spring portion in a direction orthogonal to the pressed surface.

(6) The vehicle electronic component holder set according to any one of (2) to (5), wherein
the base portion has a through hole provided in a vicinity of the attachment hole along a part of the peripheral wall, and
the leaf spring portion is disposed between the attachment hole and the through hole.

(7) The vehicle electronic component holder set according to (6), wherein
the through hole is elongated in the extending direction of the leaf spring portion, and
a width of the through hole is smaller than a dimension of the leaf spring portion in a direction orthogonal to the pressed surface.

(8) The vehicle electronic component holder set according to any one of (2) to (7), wherein a top portion of the protrusion that protrudes most toward the inside of the attachment hole is a flat top surface extending in the depth direction of the attachment hole.

(9) The vehicle electronic component holder set according to (8), wherein
the side surface of the shaft member is provided with a bottomed groove portion that engages with the protrusion when the shaft member is inserted into the attachment hole, and
a dimension of the top surface in the depth direction of the attachment hole is larger than a width of a bottom portion of the groove portion in an axial direction of the shaft member.

(10) The vehicle electronic component holder set according to (9), wherein
the groove portion extends in a direction intersecting the axial direction of the shaft member,
at least one wall portion of two wall portions forming the groove portion so as to sandwich the groove portion in the axial direction is inclined with respect to the axial direction of the shaft member,
the protrusion has an inclined surface that is inclined with respect to the depth direction and faces the one wall portion when the shaft member is inserted into the attachment hole, and
an inclination of the inclined surface in the protrusion with respect to the depth direction of the attachment hole is smaller than an inclination of the one wall portion of the groove portion with respect to the axial direction.

(11) The vehicle electronic component holder set according to (10), wherein
the protrusion has an end surface continuing to a side opposite to the inclined surface with respect to the top portion,
the end surface faces a direction different from the inclined surface in the depth direction, and
an inclination of the end surface of the protrusion with respect to the depth direction is larger than the inclination of the inclined surface of the protrusion with respect to the depth direction.

(12) The vehicle electronic component holder set according to any one of (2) to (11), wherein
the attachment hole has a polygonal shape, and
the leaf spring portion is provided along a part of the peripheral wall forming each of at least two adjacent sides of the attachment hole.

(13) The vehicle electronic component holder set according to any one of (2) to (11), wherein
the attachment hole has a polygonal shape,
a length of one side of the attachment hole is larger than a length of another side of the attachment hole, and
the leaf spring portion is formed to include the one side.

(14) The vehicle electronic component holder set according to any one of (1) to (13), wherein
the vehicle electronic component holder includes a case portion that encloses an electronic component,
the case portion includes a bottomed recess that has an opening on a surface of the case portion and into which the electronic component is inserted,
the opening is disposed on one side of the base portion in the depth direction of the attachment hole,
the attachment hole is disposed outward of the case portion in a direction from a bottom portion of the recess toward the opening, and
an outer surface of the protrusion facing the one side is flush with a main surface of the base portion facing the one side.

(15) A vehicle electronic component holder used together with a shaft member having a circular cross section, the vehicle electronic component holder comprising:
a base portion provided with an attachment hole through which the shaft member is inserted, wherein
the base portion includes a protrusion protruding from a peripheral wall defining the attachment hole toward an inside of the attachment hole.

What is claimed is:

1. A vehicle electronic component holder set comprising: a shaft member having a circular cross section;
and a vehicle electronic component holder, wherein the vehicle electronic component holder includes a base portion provided with an attachment hole through which the shaft member is inserted,
the base portion includes a protrusion protruding from a peripheral wall defining the attachment hole toward an inside of the attachment hole,
a distance between the protrusion and a center of the attachment hole is smaller than a radius of the shaft member as viewed from a depth direction of the attachment hole, and
when the shaft member is inserted into the attachment hole, the protrusion comes into pressure contact with a side surface of the shaft member.

2. The vehicle electronic component holder set according to claim 1, wherein
a part of the base portion is a leaf spring portion extending along a periphery of the attachment hole,
a pressed surface of the leaf spring portion is a part of the peripheral wall,
each of both ends of the leaf spring portion in an extending direction of the leaf spring portion is formed continuously with an adjacent portion of the base portion adjacent to the leaf spring portion,
a central portion of the leaf spring portion in the extending direction is separated from another part of the base portion, and
the leaf spring portion is bendable so that an intermediate portion of the leaf spring portion is displaced toward the center of the attachment hole or toward a direction opposite to the center of the attachment hole.

3. The vehicle electronic component holder set according to claim 2, wherein a dimension of the leaf spring portion in a direction orthogonal to the pressed surface that is a part of the peripheral wall is smaller than a dimension of the leaf spring portion in the depth direction of the attachment hole.

4. The vehicle electronic component holder set according to claim 2, wherein
a facing portion that is a part of the peripheral wall faces the pressed surface of the leaf spring portion across the attachment hole,
at least a part of the pressed surface of the leaf spring portion is a forming region of the protrusion, and
the facing portion is a non-forming region of the protrusion.

5. The vehicle electronic component holder set according to claim 2, wherein
a facing portion that is a part of the peripheral wall faces the pressed surface of the leaf spring portion across the attachment hole,
the base portion includes a facing wall portion that includes the facing portion and is located on a side away from the center of the attachment hole, and
a dimension of the facing wall portion in a direction orthogonal to the facing portion is larger than a dimension of the leaf spring portion in a direction orthogonal to the pressed surface.

6. The vehicle electronic component holder set according to claim 2, wherein
the base portion has a through hole provided in a vicinity of the attachment hole along a part of the peripheral wall, and
the leaf spring portion is disposed between the attachment hole and the through hole.

7. The vehicle electronic component holder set according to claim 6, wherein
the through hole is elongated in the extending direction of the leaf spring portion, and
a width of the through hole is smaller than a dimension of the leaf spring portion in a direction orthogonal to the pressed surface.

8. The vehicle electronic component holder set according to claim 2, wherein a top portion of the protrusion that protrudes most toward the inside of the attachment hole is a flat top surface extending in the depth direction of the attachment hole.

9. The vehicle electronic component holder set according to claim 8, wherein
the side surface of the shaft member is provided with a bottomed groove portion that engages with the protrusion when the shaft member is inserted into the attachment hole, and
a dimension of the top surface in the depth direction of the attachment hole is larger than a width of a bottom portion of the groove portion in an axial direction of the shaft member.

10. The vehicle electronic component holder set according to claim 9, wherein
the groove portion extends in a direction intersecting the axial direction of the shaft member,
at least one wall portion of two wall portions forming the groove portion so as to sandwich the groove portion in the axial direction is inclined with respect to the axial direction of the shaft member,
the protrusion has an inclined surface that is inclined with respect to the depth direction and faces the one wall portion when the shaft member is inserted into the attachment hole, and
an inclination of the inclined surface in the protrusion with respect to the depth direction of the attachment hole is smaller than an inclination of the one wall portion of the groove portion with respect to the axial direction.

11. The vehicle electronic component holder set according to claim 10, wherein
the protrusion has an end surface continuing to a side opposite to the inclined surface with respect to the top portion,
the end surface faces a direction different from the inclined surface in the depth direction, and
an inclination of the end surface of the protrusion with respect to the depth direction is larger than the inclination of the inclined surface of the protrusion with respect to the depth direction.

12. The vehicle electronic component holder set according to claim 2, wherein
the attachment hole has a polygonal shape, and
the leaf spring portion is provided along a part of the peripheral wall forming each of at least two adjacent sides of the attachment hole.

13. The vehicle electronic component holder set according to claim 2, wherein
the attachment hole has a polygonal shape,
a length of one side of the attachment hole is larger than a length of another side of the attachment hole, and
the leaf spring portion is formed to include the one side.

14. The vehicle electronic component holder set according to claim 1, wherein
the vehicle electronic component holder includes a case portion that encloses an electronic component,
the case portion includes a bottomed recess that has an opening on a surface of the case portion and into which the electronic component is inserted,
the opening is disposed on one side of the base portion in the depth direction of the attachment hole,
the attachment hole is disposed outward of the case portion in a direction from a bottom portion of the recess toward the opening, and
an outer surface of the protrusion facing the one side is flush with a main surface of the base portion facing the one side.

15. A vehicle electronic component holder used together with a shaft member having a circular cross section, the vehicle electronic component holder comprising:
a base portion provided with an attachment hole through which the shaft member is inserted, wherein
the base portion includes a protrusion protruding from a peripheral wall defining the attachment hole toward an inside of the attachment hole.
